(19) United States
(12) Patent Application Publication
(10) Pub. No.: US 2009/0139647 A1
(43) Pub. Date: Jun. 4, 2009

(54) SYSTEM AND METHOD FOR FORMING PLASTIC PALLETS

(75) Inventors: Frank W. Bradish, Kingsville, OH (US); Hochul Jung, Perry, OH (US); Charles E. Kappelt, Linesville, PA (US)

Correspondence Address: HAHN LOESER & PARKS, LLP, One GOJO Plaza, Suite 300, AKRON, OH, 44311-1076, US

(73) Assignee: MOLDED FIBER GLASS TRAY COMPANY, Linesville, PA (US)

(21) Appl. No.: 12/267,012

(22) Filed: Nov. 7, 2008

Related U.S. Application Data
(60) Provisional application No. 60/986,790, filed on Nov. 9, 2007.

(51) Int. Cl. B32B 37/00; B29C 59/02

(52) U.S. Cl. 156/275.1; 264/320; 156/379.6; 156/380.9

(57) ABSTRACT

A preformed laminate is provided having first and second outer layers that sandwich a cellular or honeycomb shaped core. The peripheral edge of the preformed laminate may be inserted into the heating apparatus having one or more heating elements surrounded by a reflective back panel and one or more heat shields, which function to focus heat onto the peripheral edge. Once heated, the peripheral edge of the preformed laminate may then be inserted into a molding press having one or more adjustable pinch rails for forming the peripheral edge of the laminate into an enclosed pallet.

This utility patent application claims priority to U.S. provisional patent application, Ser. 60/986,790 filed on Nov. 9, 2007, which is incorporated herein by reference in its entirety.

### TECHNICAL FIELD

The present invention pertains to pallets for transporting food related and other products, and more specifically to methods and equipment for forming a plastic slip pallet.

### BACKGROUND OF THE INVENTION

Shipping pallets are well known for transporting materials in various industries. Millions of pallets are in widespread use today. Wooden pallets, in particular, have provided a platform on which numerous types of goods have been stored, transported and distributed. In one instance, food related industries have used wooden pallets. Such pallets are well suited for stacking and transporting products. They allow for the efficient storage and easy handling of bundled products.

However, while wooden pallets work well to store and transport materials, they are not well suited for use in environments requiring more sanitary conditions. Wood absorbs and holds in contaminants. It contains cracks and other imperfections in the surface where dirt and micro-organisms readily accumulate. As a result, mold, bacteria and parasites grow and live on the pallet surfaces. Constant cleaning or fumigation is required to maintain adequate health standards. For example, fish and meat are easily contaminated by simple contact with a pallet. Additionally, splinters of wood picked up by the food products being transported also pose a significant health risk.

To address the problems of utilizing wooden pallets, technology has afforded a more sanitary solution in recent years, namely the use of plastics in constructing pallets. Polypropylene is one type of plastic well suited for this application. The surface is impervious to contaminants, unlike wood, and is easily cleaned and sanitized. But, the cost of producing plastic pallets can be quite high in some cases up to ten times as much as their wooden counterparts.

The process of producing plastic pallets is also somewhat complex and typically requires the use of ovens, conveyors and compression presses, along with molds and other tooling. One method of producing a plastic pallet uses a cellular or honeycomb core sandwiched between two or more layers of sheet material. The sandwich laminate increases the stiffness and strength of the plastic pallets, while at the same time decreases weight. The materials are typically loaded into the oven on a conveyor and subsequently into a mold where they are compressed or thermoformed thereby fusing the skins and the core material together. The primary purpose of the honeycomb core is to distribute stresses over a relatively large surface area. As a result, the structure resists bending and deforming under load.

Still, the initial investments are significant requiring the purchase, setup and operation of expensive machinery. It would be advantageous to provide a system and method for forming the plastic pallets that utilizes less expensive equipment that is easy to use and operate. The embodiments of the subject invention obviate the aforementioned problems.

### BRIEF SUMMARY

In one embodiment of the subject invention, a method of forming a plastic pallet includes the steps of providing a preformed laminate having one or more peripheral edges, heating the region proximate to the one or more peripheral edges, and compressing the heated region thereby forming a contoured pallet.

In one aspect of the embodiments of the subject invention, the preformed laminate comprises the first and second outer layers that sandwich an inner core, which may have a cellular configuration and more specifically, a honeycomb configuration.

In another aspect of the embodiments of the subject invention, the inner core may be comprised of a plurality of cells contiguously formed into a unitary article.

In still another aspect of the embodiments of the subject invention, the preformed laminate is constructed from a moldable polymer, which may be a thermoplastic and in particular, polypropylene.

In another embodiment of the present invention, a method of forming a pallet for transporting or storing associated objects includes the steps of: providing one or more sheets of generally planar material for supporting one or more associated objects where the one or more sheets define at least a first peripheral edge, and heating a portion of the one or more sheets of generally planar material for changing the shape of the pallet, and reshaping at least part of the pallet.

In one aspect of the embodiments of the subject invention the method includes heating a localized region proximate to the at least a first peripheral edge for changing the shape of the pallet, and reshaping the at least a first peripheral edge of the pallet.

In another embodiment of the subject invention, a system for reshaping an associated laminate having a peripheral edge includes a heating apparatus for applying energy to a localized region having a heating chamber configured to surround a portion of the associated laminate, the heating apparatus having at least one heating element operable to deliver energy into the heating chamber for reshaping the peripheral edge of the associated laminate. The system also include means for applying reshaping force to the peripheral edge of an associated preformed laminate.

In one aspect of the embodiments of the subject invention, the system the heating chamber is generally longitudinal and has a fixed depth. Additionally, the heating chamber includes a slot through which a portion of the associated laminate is inserted into the heating chamber.

In another aspect of the embodiments of the subject invention, the at least one heating element is mounted substantially within the interior of the heating chamber.

### BRIEF DESCRIPTION OF THE DRAWINGS

FIG. 1 is a partial cutaway perspective view of a pallet according to the embodiments of the invention.

FIG. 2 is a partial perspective view of a pre-formed laminate according to the embodiments of the invention.

FIG. 3 is a partial side view of the pallet according to the embodiments of the invention.

FIG. 4 is a partial cutaway side view of a localized heating apparatus according to the embodiments of the subject invention.

FIG. 5 is a partial cutaway side view of a molding press according to the embodiments of the subject invention.

FIG. 6 is a block diagram of a method of forming a pallet for transporting or storing associated objects according to the embodiments of the subject invention.

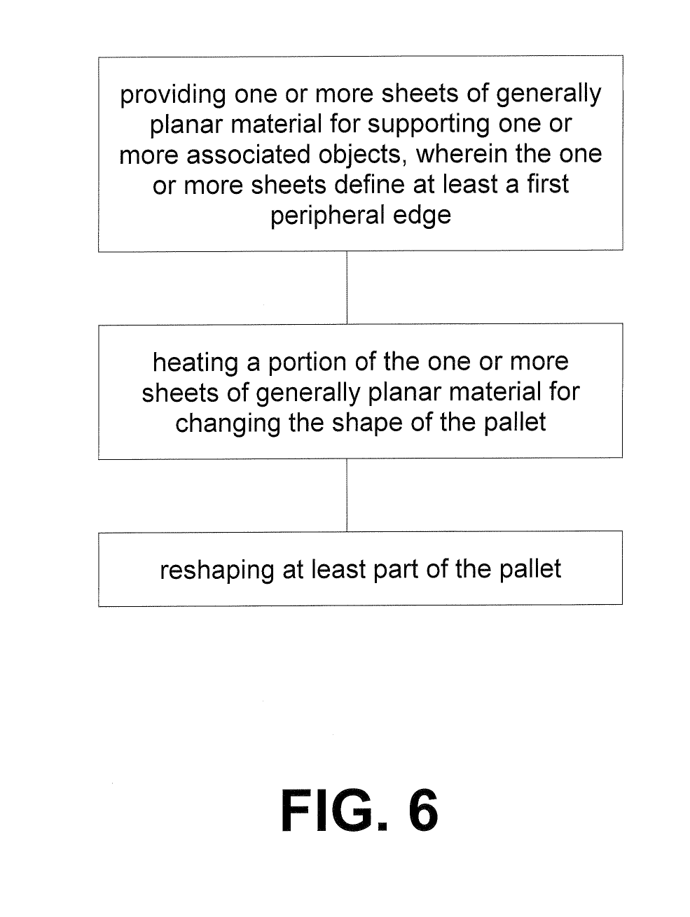

FIG. 7 is a block diagram of a method of forming a pallet made from polymeric material according to the embodiments of the subject invention.

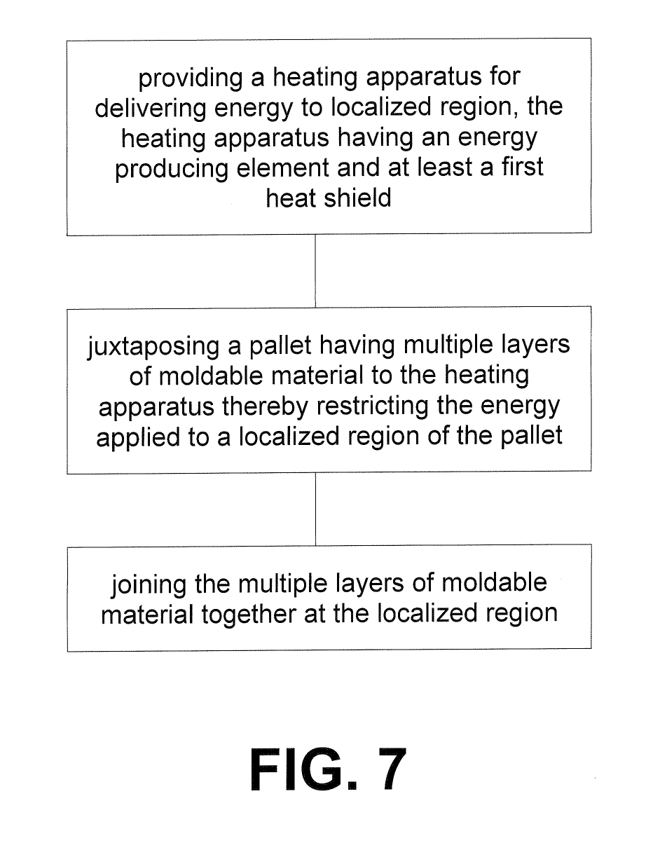

### DETAILED DESCRIPTION OF THE INVENTION

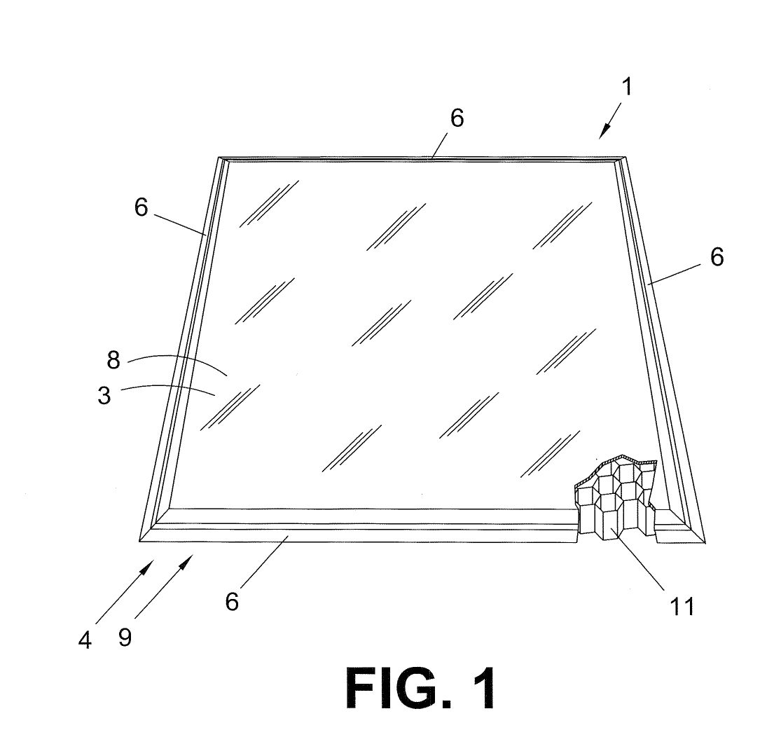

Referring now to the drawings wherein the showings are for purposes of illustrating embodiments of the invention only and not for purposes of limiting the same, FIG. 1 shows a pallet depicted generally at 1. The pallet 1 may be utilized to store and transport goods between locations. One exemplary type of product transported by the pallet 1 may pertain to food related items. However, any type of goods may be loaded onto the pallet 1 and stored or transported as is appropriate for use with the embodiments of the subject invention. The pallet 1 may be generally planar having first and second sides 3, 4. On each of the sides 3, 4, the surfaces may be substantially uniform terminating in pallet edges 6 that may be contoured as will be described in a subsequent paragraph. The pallet 1 may be constructed of a polymer material, such as for example a thermoplastic material. Polypropylene is just one type of a thermoplastic that may be utilized to construct the pallet 1, as it is resistance to bacteria and other contaminants detrimental to sanitary environments like the food processing and packaging industry. It is to be construed that any type moldable material and more specifically moldable plastic may be used to construct the pallet 1 as is appropriate for use with the embodiments of the subject invention. The pallet 1 may have a polygonal configuration, which in an exemplary manner may be substantially square. More specifically, the pallet 1 may be 4 feet by 4 feet in dimension having a thickness in the range between 0.5 inch to 2 inches. However, persons of ordinary skill in the art will readily understand the application of the embodiments of the subject invention to any configuration and/or size of pallet 1.

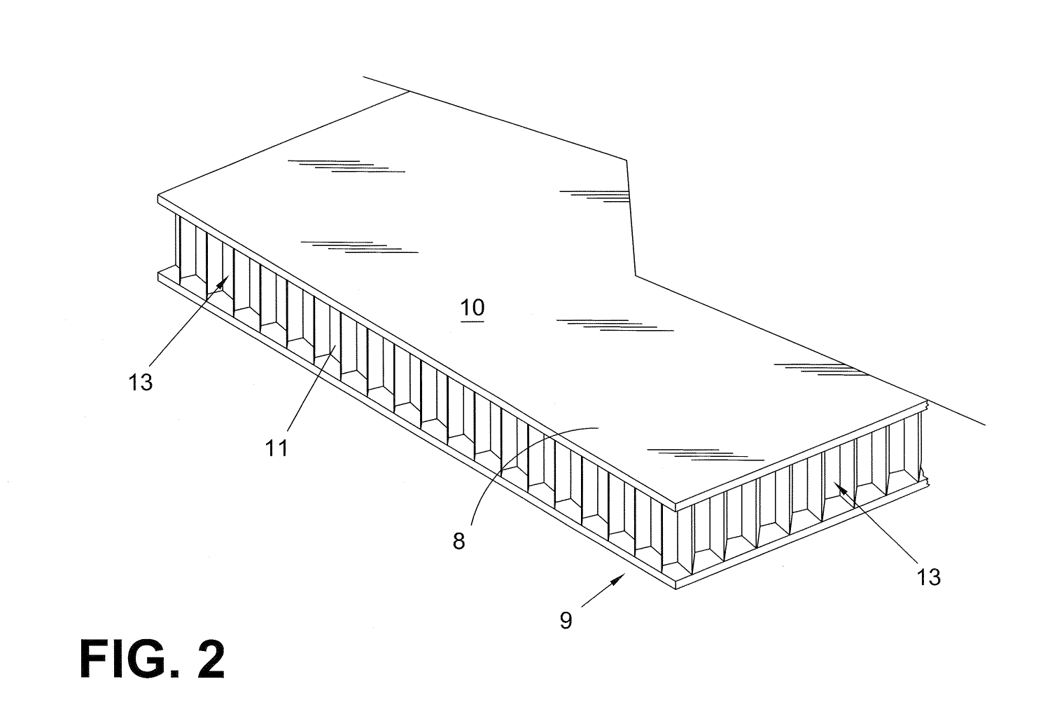

With continued reference to FIG. 1 and now also to FIG. 2, the pallet 1 may be constructed having multiple layers of materials. In one embodiment, all of the layers may be comprised of polymer material, which may be any polymer material having properties suitable for constructing a rigid pallet 1. The layers may include first and second outer layers 8, 9 or skins that sandwich a core 11. The first and second outer layers 8, 9 may be comprised of sheet plastic having a thickness in the range of 0.025 inch to 0.125 inch. The core 11 may be cellular in nature. In particular, the core 11 may have a honeycomb cross section comprising a contiguously formed or monolithic structure. This reduces the overall weight while providing sufficient rigidity for the pallet 1. The core 11 may have a thickness between 0.750 inch to 1.125 inches. Although, it is to be understood that any thickness of the first and second layers 8, 9 and any thickness of core 11 may be chosen with sound engineering judgment. During the formation process, the layers 8, 9, and 11 may be fused by heating and compressing the juxtaposed members together. In one phase of construction, the ends 13 of the layered materials may remain open in preparation for forming the pallet edges 6 in a subsequent process, as will be discussed in detail below. In this manner, the fused first and second outer layers 8, 9 and core 11 having open ends 13 comprise a pre-formed laminate 10.

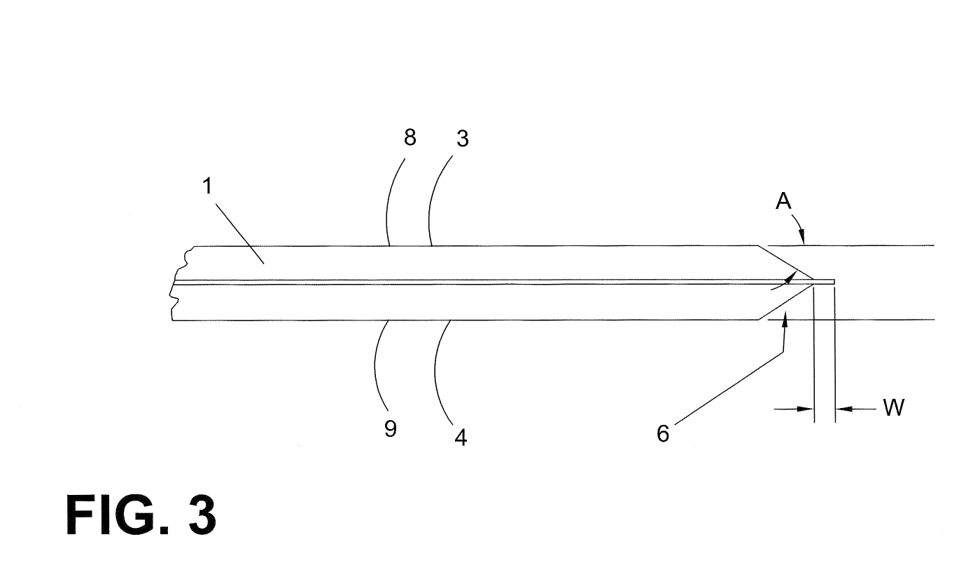

With reference now to FIGS. 1 and 3, in a subsequent forming process, the open ends 13 of the laminate 10 may be fashioned or formed to enclose the core 11. More specifically, the first and second outer layers 8, 9 may be formed so as to encapsulate the core 11 by compressing the open ends 13. In one embodiment, the open ends 13 may be thermoformed and compressed in a mold thereby providing a contoured edge surface, which may be tapered, for easy pick up by tow motor, fork lift or other device. Initially the layers 8, 9, 11 may be fashioned to size and then fused together in a first process thus producing the pre-formed laminate 10. In a subsequent step, a peripheral portion of the laminate 10 may be heated to a temperature, appropriate for softening the type of material being utilized, and subsequently pressure formed thereby compressing and forming the peripheral edge of the pallet 1. In one embodiment, only the peripheral portion of the laminate 10 may be subjected to heat and subsequent compression. That is to say that heat input may be limited to the peripheral portion of the laminate 10. In this way, the edges 6 of the pallet 1 may be thermoformed in a localized manner. This comprises a unique process not known in the art. It will be appreciated by persons of ordinary skill in the art that the distinctive processes of forming the laminate 10 and subsequently forming the pallet 1 may be performed at different locations and/or by different manufacturers. In fact, the pre-formed laminate 10 may comprise a commodity provided to an end-user for subsequently forming the edges 6 in a particular configuration suited to a specific application.

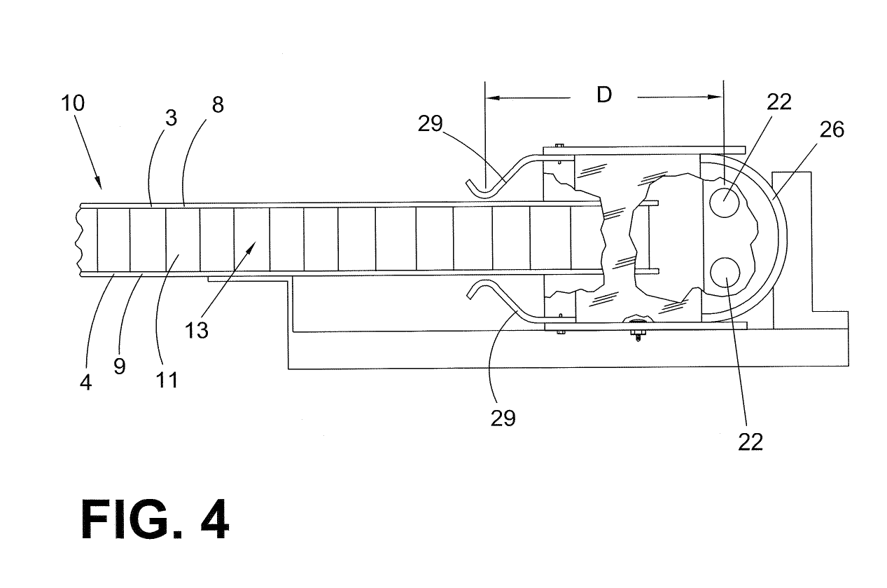

With reference now to FIG. 4, a heating apparatus 18 is provided that will heat a peripheral portion of the laminate 10. The heating apparatus 18 may be generally longitudinal having a length corresponding to the length of the pallet sides. However, any length of the heating apparatus 18 may be chosen as is appropriate for use with the embodiments of the subject invention. The heating apparatus 18 may include one or more heater elements 22 mounted within a housing 26. The heater elements 22 may be of the infrared electric heater type, although other types of heating elements may used without departing from the intended scope of coverage of the embodiments of the subject invention. In one embodiment, the heater elements 22 may be longitudinal infrared heater rods 23 substantially traversing the length of the heating apparatus 18. Heat shields 29 or deflectors may extend from the housing 26 to focus or reflect the heat onto the peripheral portion of the laminate 10. The heating apparatus 18 may include two (2) heat shields extending from opposite sides of the housing 26 for focusing heat onto both sides of laminate 10. In one embodiment, the heat shields 29 may narrow or taper to a thickness proximate to, but slightly larger than, the thickness of the laminate 10. In this manner, the tapered heat shields 29 and the housing 26, which may incorporate a reflective back panel, form a heating chamber 33 into which the peripheral portion of the laminate 10 may be inserted. The depth of the heating chamber 33 may range from between 3 inches to 7 inches. However, any dimension of the heating apparatus components and any depth of the heating chamber 33 may be chosen as is appropriate for use with softening the peripheral portions of the laminate 10. In operation, the heating apparatus 18 may be utilized in one step to form an edge 6 of the pallet 1. This step may comprise heating an outer peripheral band of the laminate 10 to a temperature sufficient to soften the edges thereby allowing it to be formed in a subsequent process as will be discussed in the next paragraph. It is noted here that not only do the heat shields 29 focus heat onto the peripheral portion of the laminate 10, but it also functions to minimize the cooling effect that the surrounding air may have on the laminate 10 while it is being heated.

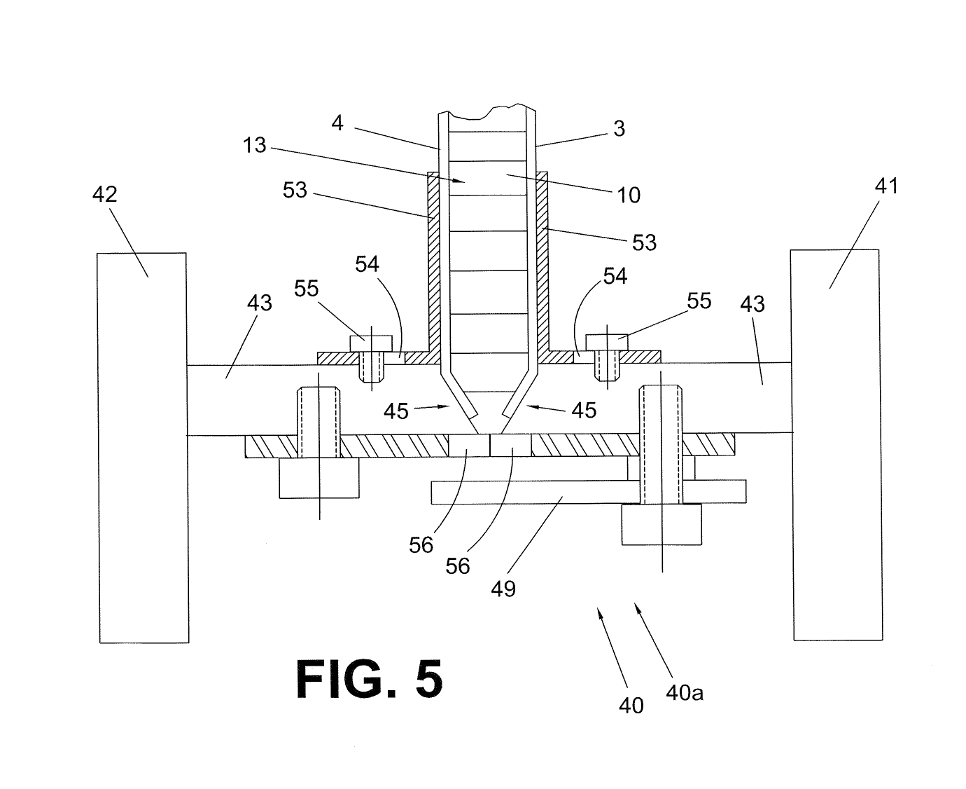

With reference now to FIG. 5, after the peripheral regions of the laminate 10 have been heated, the laminate 10 may be placed into a forming device, shown generally at 40, for compressing and shaping the peripheral portions of the laminate 10 into the pallet edge 6. The forming apparatus 40 may be a molding press 40a, which includes first and second platens 41, 42 moveable between minimum and maximum positions. The platens are capable of delivering compression forces for use in forming the edges 6 of the pallet 1. The molding press 40a may be actuated by fluid power, wherein the molding press 40a may comprise a hydraulic molding press 40a. However, it is to be construed that any means may be used to actuate the molding press 40a as chosen with sound engineering judgment. Pinch rails 43 may be used to contact and form the peripheral portions of the laminate 10. Accordingly, the pinch rails 43 may be received by the molding press 40a and positioned between the movable platens 41, 42 for transmitting force to the laminate 10. The pinch rails 43 may have a contoured forming surface 45 for fashioning the edge 6 of the pallet 1. The forming surfaces 45 may be the same for each pinch rail 43 thereby creating a generally symmetrical pallet 1. Alternatively, the forming surfaces 45 of the pinch rails 43 may be substantially different. The contour of the forming surfaces 45 may also have any shape for forming the edges 6 of the pallet 1, like for example but not limited to straight or curved surfaces. In this manner, the heated open ends 13 of the laminate 10 may be placed into the molding press 40a wherein the molding press 40a may be subsequently actuated to close the platens 41, 42 thereby compressing the edges of the laminate 10 into conformity with the surfaces 45 of the pinch rails 43.

The molding press 40a may further include stops 49 positioned between the platens 41, 42 to limit movement of the molding press 40a to a preset position. The stops 49 may be selectively adjustable with respect to the platens 41, 42 and more specifically with respect to the pinch rails 43. In one embodiment, the stops 49 may be rigid members constructed of metal or other material capable of withstanding the compression force of the molding press 40a. It is noted here that other means may also be utilized to selectively limit how far the pinch rails 43 move to compress the edge 6 of the pallet 1. Such embodiments may include but are not limited to electrical controls and sensory feedback that may be used to determine the movement of the platens 41, 42 and pinch rails 43.

With continued reference to FIG. 5, the pinch rails 43 may further include horizontal pinch rail members 53 that are attached to the main pinch rails 43. The horizontal pinch rail members 53 may be selectively adjustable with respect to the pinch rails 43 for optimizing the thickness of the pallet edge 6. The horizontal pinch rail members 53 may include slots or holes 54 and fasteners 55 used to adjust the position of the horizontal pinch rail members 53 with respect to the pinch rails 43. In this manner, the horizontal pinch rail members 53 may function to hold the laminate 10 in position as it is being formed by the molding press 40a. A backstop 56 may also be included to assist the initial placement of the laminate 10 into the molding press 40a. The backstop 56 may also be adjustable with respect to the pinch rails 43 and may function to provide molding pressure to the outside edge of the laminate 10. In this manner, each of the respective pinch rails 43 provide compression forces to the top and bottom of the laminate 10 and the backstop 56 provides compression forces to the end of the laminate 10. In operation, an operator may place the heated preformed laminate 10 into the molding press 40a and subsequently actuate the molding press 40a to engage the surfaces 45 of the pinch rails 43 with the laminate 10. The molding press 40a may then compress the heated end 13 of the laminate 10 thereby forming the edge 6 of the pallet 1 into a configuration corresponding to the contour of the surfaces 45 of the pinch rails 43. It is noted here that the molding press 40a may sufficiently compress the end 13 of the laminate 10 to seal the edge 6 of the pallet 1. That is to say that the molding press 40a may compress and fuse the layers of the laminate 10 thereby sealing the edge 6 of the pallet 1. In an exemplary manner, a 1 inch thick laminate 10 may be compressed down to a thickness of 0.15 inch. However, the molding press 40 a may be capable of compressing the layers of the laminate 10 down to thicknesses in the range of 0.025 inch.

The invention has been described herein with reference to the preferred embodiment. Obviously, modifications and alterations will occur to others upon a reading and understanding of this specification. It is intended to include all such modifications and alterations insofar as they come within the scope of the appended claims or the equivalence thereof.

What is claimed is:

1. A method of forming a pallet for transporting or storing associated objects, comprising the steps of:
providing one or more sheets of generally planar material for supporting one or more associated objects, wherein the one or more sheets define at least a first peripheral edge;
heating a portion of the one or more sheets of generally planar material for changing the shape of the pallet; and,
reshaping at least part of the pallet.

2. The method as defined in claim 1, wherein the step of: heating a portion of the one or more sheets of generally planar material for changing the shape of the pallet, comprises the step of:
heating a localized region proximate to the at least a first peripheral edge for changing the shape of the pallet; and,
wherein the step of: reshaping at least part of the pallet, comprises the step of:
reshaping the at least a first peripheral edge of the pallet.

3. The method as defined in claim 2 wherein the step of reshaping the at least a first peripheral edge of the pallet, comprises the step of:
compressing the localized region to reshape the at least a first peripheral edge of the pallet.

4. The method as defined in claim 3, wherein the one or more sheets of generally planar material comprise a laminate having at least two layers of material forming one or more open peripheral edges; and wherein the step of compressing the localized region to reshape the at least a first peripheral edge of the pallet, comprises the step of:
compressing the localized region to reshape the at least a first peripheral edge thereby sealing the one or more open peripheral edges of the pallet.

5. The method as defined in claim 4, wherein the laminate is preformed and comprises first and second outer layers affixed to an inner core.

6. The method as defined in claim 5, wherein the inner core comprises a plurality of contiguously formed cells.

7. The method as defined in claim 6, wherein at least part of the inner core has a honeycomb cross sectional configuration.

8. The method as defined in claim 1, wherein the generally planar material is a thermoplastic material.

9. The method as defined in claim 8, wherein the generally planar material is at least partially comprised of polypropylene.

10. A method of forming a pallet made from multiple layers of polymeric material, comprising the steps of:
providing a heating apparatus for delivering energy to localized region, the heating apparatus having an energy producing element and at least a first heat shield;
juxtaposing a pallet having multiple layers of moldable material to the heating apparatus thereby restricting the energy applied to a localized region of the pallet; and,
joining the multiple layers of moldable material together at the localized region.

11. The method as defined in claim 10, wherein the at least a first heat shield is configured to deflect energy into a localized region; and,
wherein the localized region is a peripheral edge of the pallet.

12. The method as defined in claim 11, further comprising the steps of:
providing a device for applying compression force to the peripheral edge of the pallet, the device having one or more moveable pinch rail members;
juxtaposing the pallet to the one or more moveable pinch rail members;
engaging the one or more moveable pinch rail members to contact the pallet thereby fusing the multiple layers of moldable material together.

13. The method as defined in claim 12, wherein the one or more pinch rail members define a contour; and further comprising the step of:
reshaping the pallet to the contour defined by the one or more pinch rail members.

14. A system for reshaping an associated laminate having a peripheral edge, comprising:
a heating apparatus for applying energy to a localized region having a heating chamber configured to surround a portion of the associated laminate, the heating apparatus having at least one heating element operable to deliver energy into the heating chamber for reshaping the peripheral edge of the associated laminate; and,
means for applying reshaping force to the peripheral edge of an associated preformed laminate.

15. The system as defined in claim 14, wherein the heating chamber is generally longitudinal and has a fixed depth; and,
wherein the heating chamber includes a slot through which a portion of the associated laminate is inserted into the heating chamber.

16. The system as defined in claim 15, wherein the at least one heating element is mounted substantially within the interior of the heating chamber.

17. The system as defined in claim 15, wherein the heating chamber comprises:
a housing; and,
at least a first heat shield extended from the housing.

18. The system as defined in claim 17, wherein the at least a first heat shield comprises first and at least a second heat shield extended from the housing and configured to form the slot.

19. The system as defined in claim 14, wherein the at least one heating element comprises:
one or more infrared heating elements; and further comprising:
a reflective back panel for focusing energy with the heating chamber.

20. The system as defined in claim 14, wherein said means for applying reshaping force includes a molding press having one or more moveable platens and one or more pinch rails mounted to the one or more moveable platens for forming the peripheral edge.
